(19) United States
(12) Patent Application Publication
(10) Pub. No.: US 2023/0179840 A1
(43) Pub. Date: Jun. 8, 2023

(54) AUTONOMOUS COLLECTION OF MULTIMEDIA EVENTS FOR PRESENTATION

(71) Applicant: AT&T Intellectual Property I, L.P., Atlanta, GA (US)

(72) Inventors: Brian M. Novack, St. Louis, MO (US); Rashmi Palamadai, Naperville, IL (US); Tan Xu, Bridgewater, NJ (US); Eric Zavesky, Austin, TX (US); Ari Craine, Marietta, GA (US); Richard Palazzo, Stewartsville, NJ (US); Robert Koch, Peachtree Corners, GA (US)

(21) Appl. No.: 17/541,041

(22) Filed: Dec. 2, 2021

(51) Int. Cl. H04N 21/8549; H04W 4/38; H04W 4/02; G06Q 30/06

(52) U.S. Cl. CPC H04N 21/8549; H04W 4/38; H04W 4/025; G06Q 30/0641

(57) ABSTRACT

The disclosed technology is directed towards collecting data, including multimedia content, for creating a multimedia presentation associated with an event being experienced by a user. Location data of a user's mobile device can be used to determine availability of sensor(s) within a proximity of the mobile device, along with one or more multimedia sensor of the mobile device. The user can select a source group of the available sensors to obtain data from them, including multimedia content such as camera video and microphone audio feeds. The sensor data received from the selected sensor source group is used, optionally along with previously recorded multimedia content, to create and output the multimedia presentation associated with the event. The user can add annotations including user input and the previously recorded multimedia content for inclusion in the multimedia presentation.

### TECHNICAL FIELD

The subject application relates to the capture of information in general, and, more particularly, to collection of multimedia and other data from various sources for social media posting or other future presentation.

### BACKGROUND

Contemporary users of media are often equipped with smart devices such as smartphones, smart watches, or other wearables. A smart device may have sensors such as a camera, a microphone and for location detection capabilities. Various other sensors, such as biometric sensors (sensing the wearer's heart rate, temperature and other data) are often controlled by or coupled to a user. Also, there can be other external sensors not directly controlled by or coupled to the user, such as environmental sensors for sensing humidity, temperature, and the like.

Despite the availability of these various data, a user cannot easily capture such data and content from a number of otherwise available sources, including for creating a multimedia package that captures and enhances an event that he or she experienced. Moreover, the user may not easily be able to identify what data and content sources are available from which to retrieve data and content.

### BRIEF DESCRIPTION OF THE DRAWINGS

Non-limiting and non-exhaustive embodiments of the subject disclosure are described with reference to the following figures, wherein like reference numerals refer to like parts throughout the various views unless otherwise specified.

FIG. 1 is a block diagram illustrating an example scene of a user in a surrounding real-world environment with a user device configured to collect various data related to an event the user is experiencing, in accordance with various aspects and embodiments of the subject disclosure.

FIG. 2 is an example representation of a multimedia presentation of an event based on various data and content associated with that event, in accordance with various aspects and embodiments of the subject disclosure.

FIG. 3 is a block diagram illustrating an example scene of a user in a surrounding real-world environment, including external sensors (cameras and a microphone) that make data available, along with a user device configured to collect various data related to an event the user is experiencing, in accordance with various aspects and embodiments of the subject disclosure.

FIG. 4 is a block diagram illustrating an example scene of a user in a surrounding real-world environment including external sensors that make supplementary content available, in accordance with various aspects and embodiments of the subject disclosure.

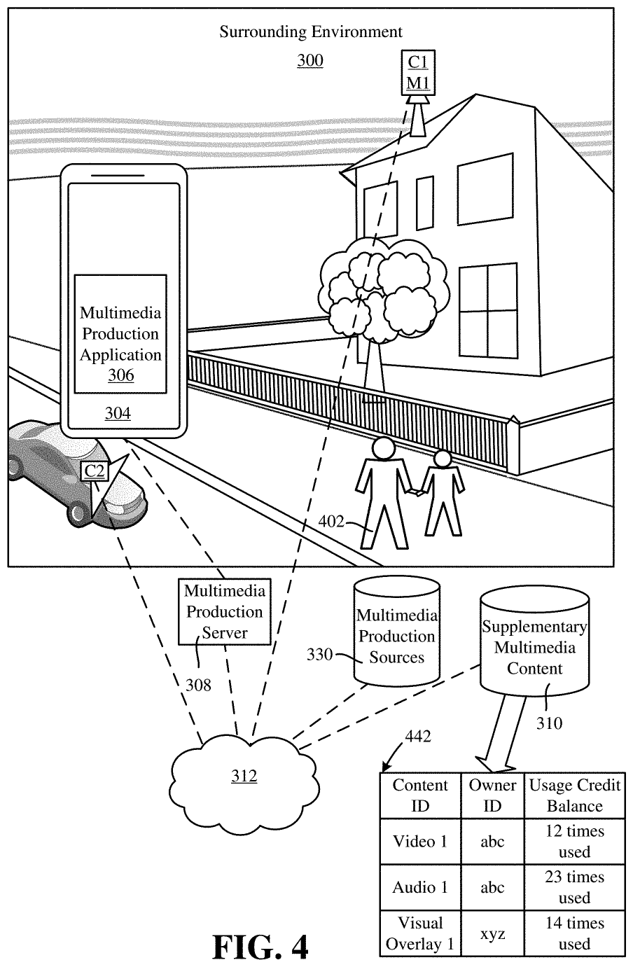

FIG. 5 is a representation of an example user interface by which a user can obtain live data from various sensors, in accordance with various aspects and embodiments of the subject disclosure.

FIG. 6 is a representation of an example user interface by which a user can obtain stored data including multimedia content, in accordance with various aspects and embodiments of the subject disclosure.

FIG. 7 is a representation of an example user interface by which a user can add annotations to the multimedia presentation of the event, in accordance with various aspects and embodiments of the subject disclosure.

FIG. 8 is a block diagram representation of example components including a data store for storing and a social media server for posting/streaming multimedia production packages, in accordance with various aspects and embodiments of the subject disclosure.

FIG. 9 is a block diagram/dataflow representation of example components related to creating a multimedia production package from collected content, in accordance with various aspects and embodiments of the subject disclosure.

FIG. 10 is a flow diagram representing example operations related to creating a multimedia file associated with an event related to a user, in which the event is associated with location data of a user device, in accordance with various aspects and embodiments of the subject disclosure.

FIG. 11 is a flow diagram representing example operations related to creating and outputting multimedia presentation associated with an event related to a user and a location of a mobile device, in accordance with various aspects and embodiments of the subject disclosure.

FIG. 12 is a flow diagram representing example operations related to combining received media content with other media content to create a multimedia presentation associated with an event, in accordance with various aspects and embodiments of the subject disclosure.

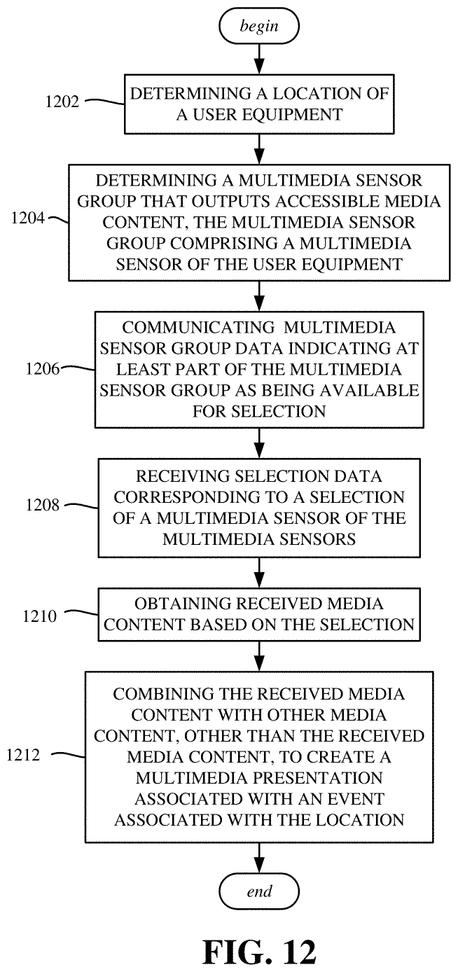

FIG. 13 illustrates an example block diagram of an example mobile handset operable to engage in a system architecture that facilitates wireless communications according to one or more embodiments described herein.

FIG. 14 illustrates an example block diagram of an example computer/machine system operable to engage in a system architecture that facilitates wireless communications according to one or more embodiments described herein.

### DETAILED DESCRIPTION

The technology described herein is generally directed towards autonomous detection of available data including media content from various sources, along with the collection of real-time and previously-stored content to create a multimedia production (e.g., a package) corresponding to a user-experienced event. The multimedia production may be posted to a user's social media account or stored elsewhere. For example, upon creation such a multimedia package (e.g., a file) may then be presented in real-time or near real-time, such as a social media broadcast, or may be saved, and potentially edited, for later presentation to the user or another party.

In one implementation, an application running on user equipment such as a smartphone communicates with a multimedia production service (e.g., on an edge and/or cloud server) to collect various data and create the multimedia production (e.g., create the multimedia production to at least some extent). The application may prompt the user for input to assist in the data collection; however the application program and/or production service may control data collection without requiring such a prompt for user input.

As used in this disclosure, in some embodiments, the terms “component,” “system” and the like are intended to refer to, or include, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component.

One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

Moreover, terms such as “mobile device equipment,” “mobile station,” “mobile,” subscriber station,” “access terminal,” “terminal,” “handset,” “communication device,” “mobile device” (and/or terms representing similar terminology) can refer to a wireless device utilized by a subscriber or mobile device of a wireless communication service to receive or convey data, control, voice, video, sound, gaming or substantially any data-stream or signaling-stream. The foregoing terms are utilized interchangeably herein and with reference to the related drawings. Likewise, the terms “access point (AP),” “Base Station (BS),” BS transceiver, BS device, cell site, cell site device, “gNode B (gNB),” “evolved Node B (eNode B),” “home Node B (HNB)” and the like, can be utilized interchangeably in the application, and can refer to a wireless network component or appliance that transmits and/or receives data, control, voice, video, sound, gaming or substantially any data-stream or signaling-stream from one or more subscriber stations. Data and signaling streams can be packetized or frame-based flows.

Furthermore, the terms “user equipment,” “device,” “communication device,” “mobile device,” “subscriber,” “customer entity,” “consumer,” “customer entity,” “entity” and the like may be employed interchangeably throughout, unless context warrants particular distinctions among the terms. It should be appreciated that such terms can refer to human entities or automated components supported through artificial intelligence (e.g., a capacity to make inference based on complex mathematical formalisms), which can provide simulated vision, sound recognition and so forth.

Embodiments described herein can be exploited in substantially any wireless communication technology, including, but not limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra mobile broadband (UMB), high speed packet access (HSPA), Z-Wave, Zigbee and other 802.11 wireless technologies and/or legacy telecommunication technologies.

One or more embodiments are now described with reference to the drawings, wherein like reference numerals are used to refer to like elements throughout. In the following description, for purposes of explanation, numerous specific details are set forth in order to provide a thorough understanding of the various embodiments. It is evident, however, that the various embodiments can be practiced without these specific details (and without applying to any particular networked environment or standard).

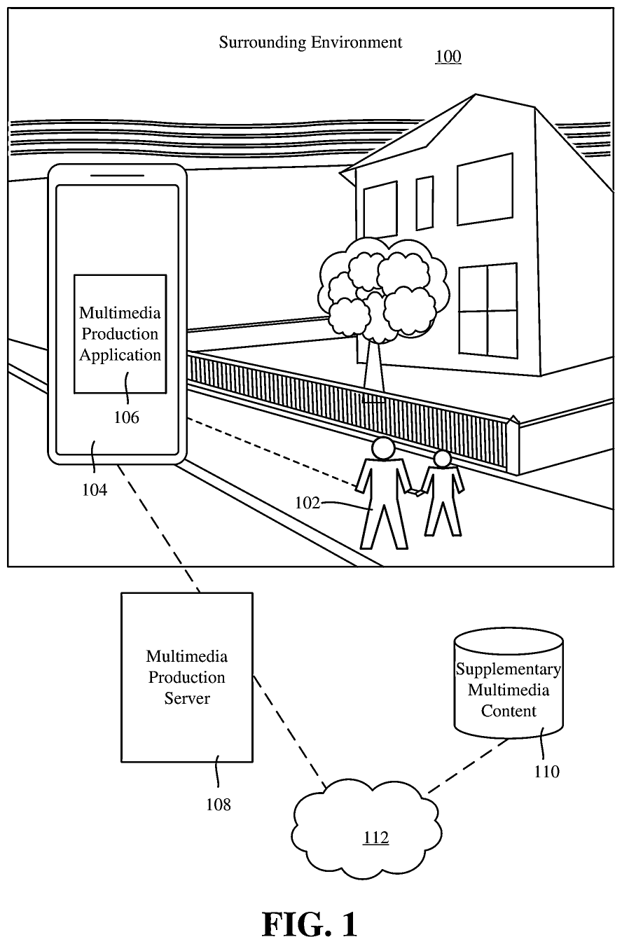

FIG. 1 shows a real-world scene represented as part of a surrounding environment, 100 within which a user 102 (e.g., a father, with his daughter) are experiencing some event, such as a meaningful event to them, or heading towards such an event. The user 102 is equipped with a smart user equipment/device such as a smartphone 104 (as shown in the example of FIG. 1), but alternatively or in addition to such a device, can be wearing a smart watch, or other wearable. This device, e.g., the smartphone 104, may be equipped with location capabilities, a camera, a microphone, and various sensors, such as incorporating or coupled to biometric sensors (e.g., sensing heart rate and other data). The user equipment can be configured with humidity, temperature, and other environmental sensors, and/or such data can be obtained (e.g., from the internet) based on the user's location.

The user equipment shown in FIG. 1 as the smartphone 104 is running a multimedia production application program 106 that collects data and multimedia content from these sensors and from other sources, for instance, over the internet. As described herein, the other data sources can include multimedia sensors, such as camera and microphones, that make their captured data available.

Also shown in FIG. 1 is a multimedia production server 308 108 and supplementary multimedia content 110, coupled together in some way, e.g., via a cloud service or set of services 112. The multimedia production server 308 108 creates and/or facilitates creation of a multimedia presentation based on the data collected by the multimedia production application program 106.

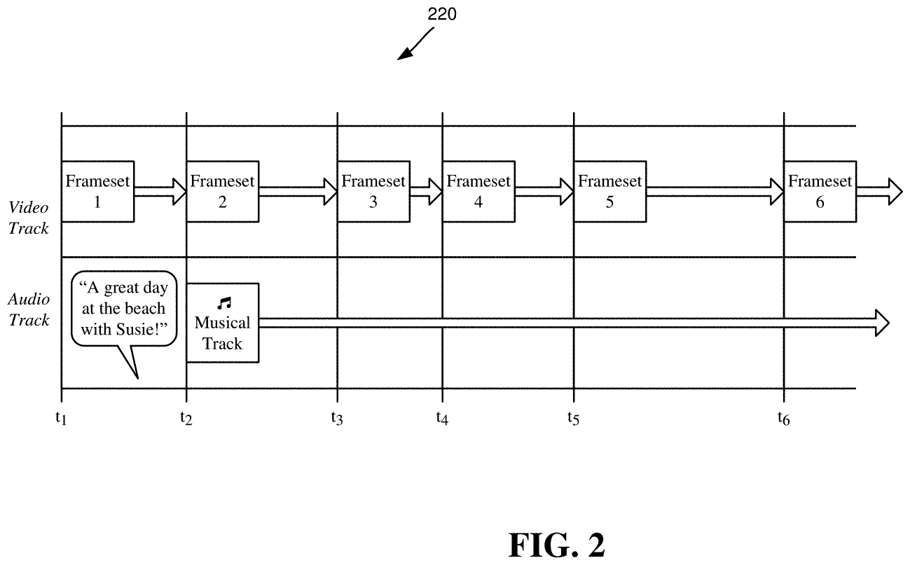

FIG. 2 shows a representation of an example multimedia presentation (package) 220 that captures and enhances an event that a user experiences; the multimedia presentation starts and time t1 and continues past time t6. For example, the first frameset 1 can be a short video introducing the content to be presented, such as a father and daughter explaining their day; as can be seen, the audio track indicates that “A great day at the beach with Susie!” is the general theme for the multimedia presentation. Although not explicitly shown in FIG. 2, it is understood that text content such as a title can overlay the video, special effects and animations can be used, annotations can be included live or later added, and so forth. Other framesets can include pre-recorded available video from a content source, more video capturing the actual event, an image/graphics/animations displayed over a number of frames, still more video capturing the actual event and so on. Audio in the form of a musical track is shown starting at time t2 to accompany the framesets numbered 2 and beyond; it is understood that multiple and/or musical tracks can be part of the multimedia presentation, audio capturing the actual event can be part of the multimedia presentation, and so on.

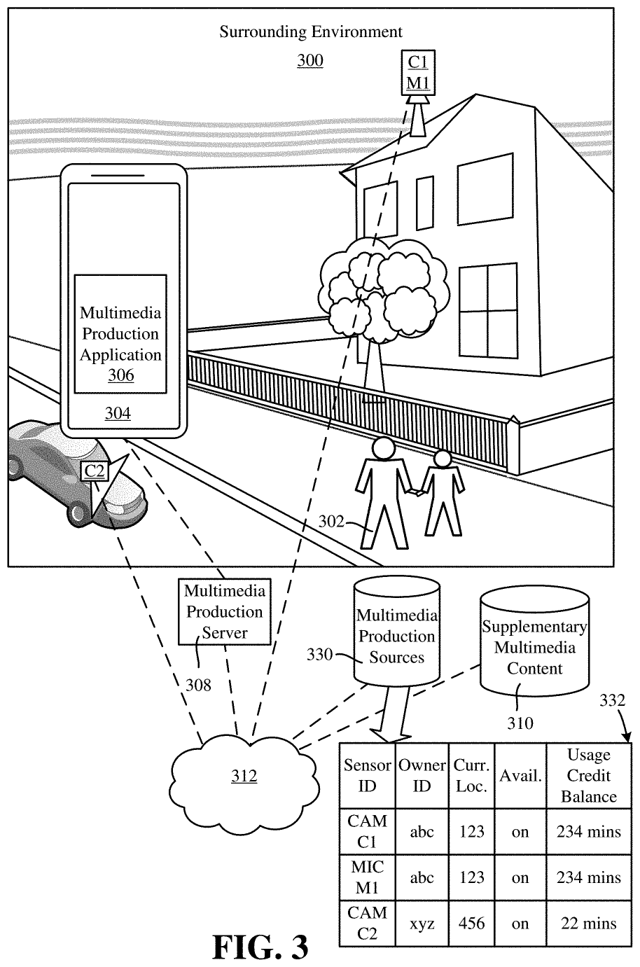

FIG. 3 shows generally the same scene in a slightly varied environment 300; (the labels labeled 1xx in FIG. 1 are labeled 3xx in FIG. 3 for like components). Note that in FIG. 3, a camera C1 and microphone M1 are mounted to the building, and as described herein, their owner has made their respective content available to others for collecting data therefrom. Similarly, the owner of a car dashboard camera C2 its respective content available to others. For such a non-stationary sensor, such as another user's device, a car or a drone, the multimedia production server 308 can detect when the current location of the camera C2 is within a threshold proximity of the user device 304, and determine whether the user is visible to the camera based on camera orientation data, if available.

To prepare for a session corresponding to an event, the multimedia production application program 106 may be in communication with the multimedia production server 308. The multimedia production server 308 may therefore obtain the location of the user. The server may also therefore know the location of other sensors in the vicinity of the user that may be available to capture content for the multimedia production. In this example these other sensors include cameras C1 and C2 and microphone M1, which have registered their presence with the multimedia production server 308, possibly for a fee or for some other reason, such as publicity for a business associated with the sensor(s). For instance, the owners of camera 1, microphone 1, and camera 2 may opt in and register their sensors' current locations and availability for use by the multimedia production server 308 and store this registration in a multimedia production sources data store (e.g., database) 330. As can be seen in FIG. 3, the multimedia production sources data store 330 contains records 332 or the like that relate sensor identifiers (IDs) to owner IDs, current location data, availability data and other information such as usage-related data.

One or more supplementary multimedia content sources, such as the supplementary multimedia content source 310 also may be registered for availability, and may store multimedia content data elsewhere in a remote location or locations. The supplementary multimedia content may be a number of different types. For example, supplementary multimedia content may include one or more video files, one or more audio files, such as narration or music, one or more visual overlays or animations that may be presented on top of other multimedia, such as video, and so forth. Audio files can be mixed, e.g., actual audio recorded during the event mixed with some background music. As described herein, access to the available real-time multimedia sources as well as pre-stored supplementary multimedia sources may be readily and immediately/near immediately available to the multimedia production server 308 at any time that the user requests the beginning of creating a session.

The user may request the beginning of a multimedia production session. Such a request may be via their device 304 and may be initiated via a display or via spoken request, or in some other way, such as a recognized movement corresponding to a gesture. As a result, the multimedia production application 306 may retrieve, from the multimedia production server 308, a listing and visualization (e.g., a preview view for video) of the available live multimedia sources.

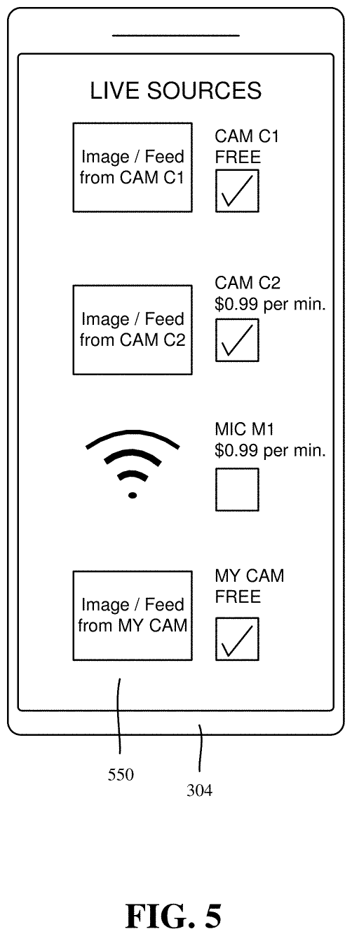

As represented in the example user interface 550 of FIG. 5 presented on the device 104, this list/grouping or the like includes any sources that the user has on the device 304 (and/or are coupled to the user), as well as any sources that are determined to be available from the multimedia production sources data store 330. The live preview views of sources that are remote from the user may be obtained by the multimedia production server 308 communicating with each of those devices and retrieving a live stream (or at least an image showing perspective) from each of the sources.

For any remote camera that is directionally controllable, the multimedia production server 308 may send a signal to that camera to alter its orientation based on the location of the user, such that the camera is oriented to focus on the user's current location. The signal level of any available remote microphones may be presented based on an analysis of the user's current location as opposed to the microphone's location. The more distant the microphone is from the user, the lower the level of signal strength for the microphone that will be presented. Note that similar to camera reorientation, audio beamforming technology can be used with microphones to capture audio based on the user's location.

Via such a user interface 550, the user may select which live sources to access and use for the creation of the multimedia package. Upon selection, streams from each of the selected sources are sent to the multimedia production server 308 until the time when the user indicates that the session is to end, or the server 308 and/or application 306 otherwise determines the end time of the session. Each live source may have an owner associated with it, as set forth herein. If a live source is selected for the creation of a multimedia package, the owner's record of that source is credited in the database so that the owner may be compensated for its use.

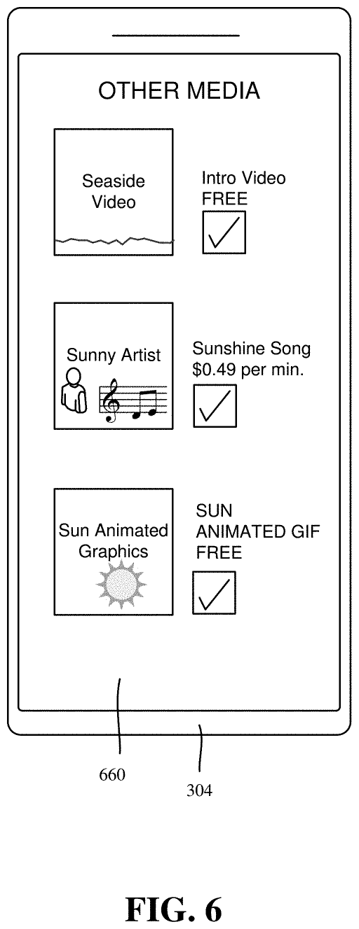

As shown in the example user interface 660 of FIG. 6, the user also may be presented with other media that may be used in the creation of the multimedia package. This media may be presented from the supplementary multimedia content database 310 and may be from more than one source. For example, other videos, music, animation, text and other types of media may be offered. Search terms or the like, e.g., entered by the user and/or obtained from the event's context, can be used to assist the user in narrowing the selection choices, and/or suggest available multimedia content for inclusion. The specific content that may be suggested to the user may be determined based on one or more conditions of the event, such as the location, companions that are detected with the user, time of day, nearby events or landmarks, and other factors. As before, the user may select one or more of the other media elements to be used in the creation of the package.

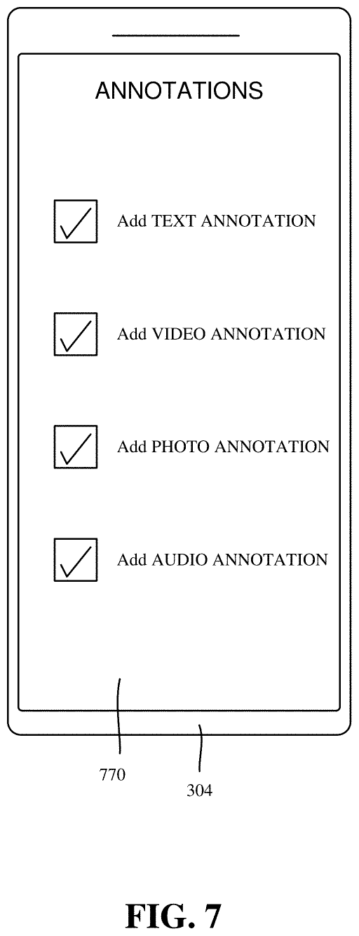

Before or during the session, the user may also create own content from the 304 device as an annotation to be included in the creation of the package, such as via the example user interface 770 of FIG. 7. For example, the user may desire to add a text, video, photo, or audio annotation. When he or she selects and specifies doing so, the user is presented with an opportunity to enter the annotation using the device 304. This may be using the capabilities of their native device to speak, capture an image, capture a video, or enter text to create a file for the annotation. For instance, the user may choose to add an audio annotation by speaking into the device and creating a voice file which is saved for the production of the package. It is also feasible to add such an annotation to a previously created multimedia package, e.g., via a suitable editor program or the like.

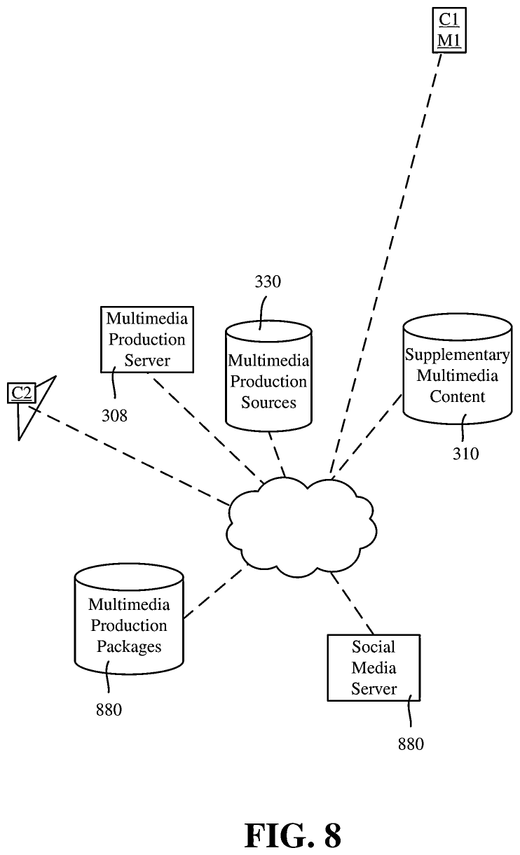

During and/or at the conclusion of a session, the live source content and data, the supplementary content, and the annotations may be collected and sent to the multimedia production server 308. Any files associated with the same event may be indicated as such, e.g., via an event identifier that may include one or more date/timestamps. As shown in FIG. 8, the data (e.g., files or links thereto, such as links to prerecorded media stored elsewhere) may be stored in a multimedia production packages data store 880 and retrieved by the multimedia production server 308 as needed, including to process and send to a social media server 882 for posting.

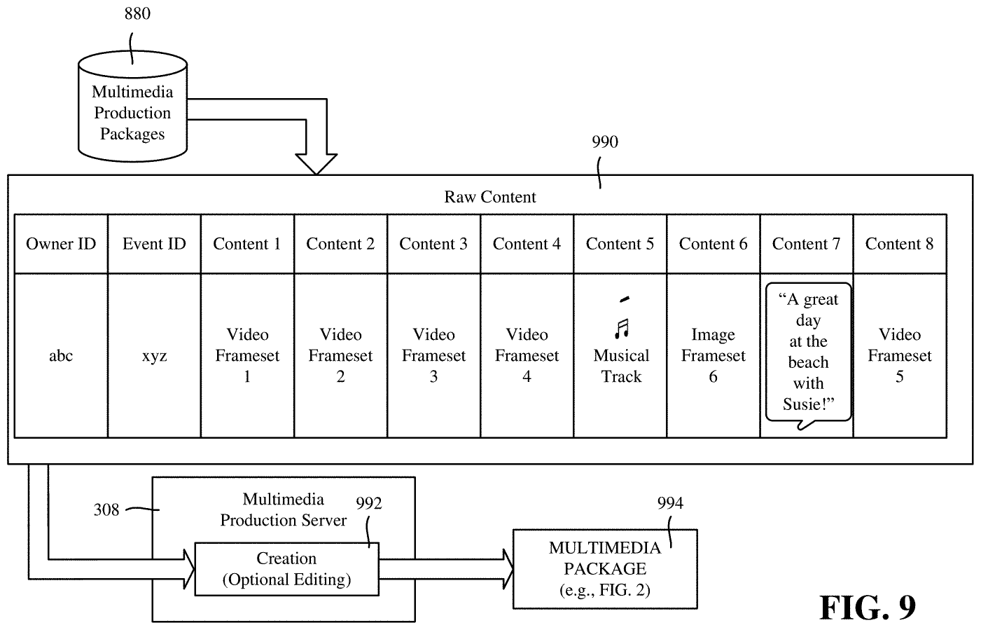

Once maintained in the multimedia production packages data store 880, these various files associated with an event are now available for the multimedia production server to thread together to create the multimedia package. As shown in the example of FIG. 9, such as during (at least in part) or at the conclusion of a session (or any time thereafter), the multimedia production server 308 may retrieve the raw content 990 (e.g., separate files) stored in the multimedia production packages data store 880. The multimedia production server 308 may combine them using one or more known creation techniques (block 992), such as including, but not limited to artificial intelligence techniques, to create a multimedia package 994 that is comprised of different sources of content. Note that the multimedia production server may select at its own discretion, for example, some files to use as fillers as needed for time to complete the package. For example, filler content can be inserted to align the end of the viewable content with the end of a song.

If the package is being created during the session, the user may specify the end of the session via a spoken or other command Otherwise, the session and may be determined by the multimedia production server by for instance, the duration of the music file or the combined duration of audio files used to create the package. The resulting multimedia package 994 that is created may be presented in real time, for instance, on the user's social media site via streaming. Alternatively, or in addition to live presentation, the multimedia package 990 also may be saved as a file for the user's own access either on their device or in a network accessible database, as well as for making available to others.

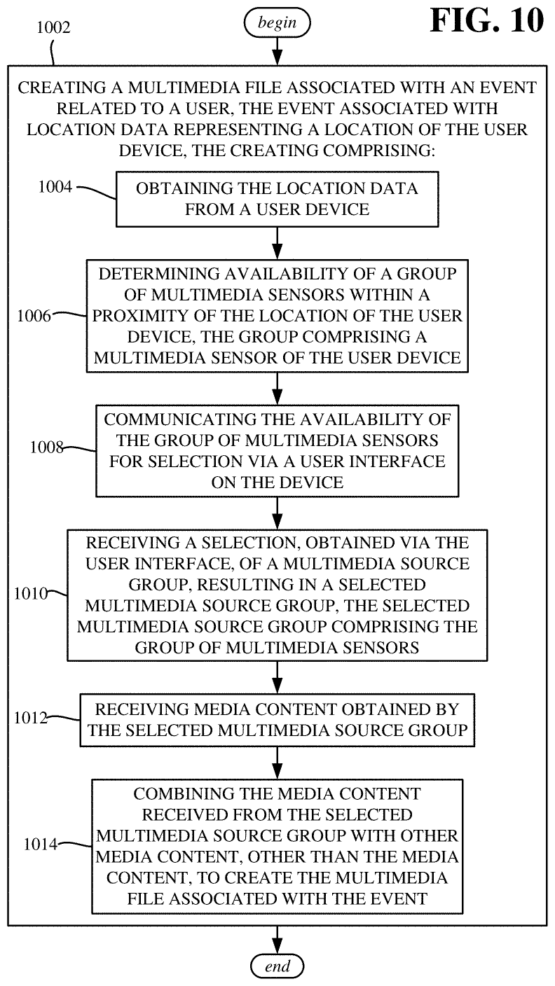

One or more example aspects are represented in FIG. 10, and can correspond to a system, including a processor, and a memory that stores executable instructions that, when executed by the processor, facilitate performance of operations. Example operation 1002 represents creating a multimedia file associated with an event related to a user, the event associated with location data representing a location of the user device. The creating can include operations 1004-1014. Operation 1004 represents obtaining the location data from a user device. Operation 1006 represents determining availability of a group of multimedia sensors within a proximity of the location of the user device, the group comprising a multimedia sensor of the user device. Operation 1008 represents communicating the availability of the group of multimedia sensors for selection via a user interface on the device. Operation 1010 represents receiving a selection, obtained via the user interface, of a multimedia source group, resulting in a selected multimedia source group, the selected multimedia source group comprising the group of multimedia sensors. Operation 1012 represents receiving media content obtained by the selected multimedia source group. Operation 1014 represents combining the media content received from the selected multimedia source group with other media content, other than the media content, to create the multimedia file associated with the event.

Further operations can include accessing the multimedia file for outputting as a presentation in response to a request from the user.

Further operations can include outputting the multimedia file to a user-specified data store.

Further operations can include outputting the multimedia file to a user-specified social media account.

The other media content comprises at least one of: audio content, video content, image content animation content, or text content.

The other media content can include at least one of: media content selected by the user, or filler content selected by the system.

The presentation of the available multimedia sensors can include respective previews for respective multimedia sensors of the group of multimedia sensors.

Further operations can include receiving an annotation from the user device for inclusion in the multimedia file.

Further operations can include receiving a pre-stored media file for inclusion in the multimedia file.

Further operations can include facilitating payment to an entity associated with a commercially offered multimedia sensor of the selected multimedia source group.

Further operations can include facilitating payment to an entity associated with commercially offered multimedia of the other multimedia content.

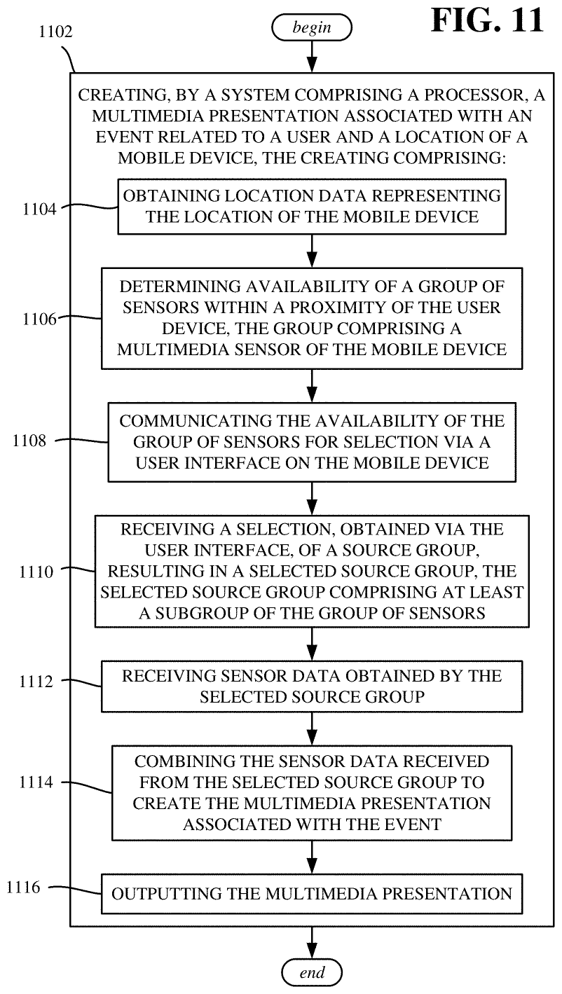

One or more example aspects are represented in FIG. 11, and, for example, can correspond to operations, such as of a method. Example operation 1102 represents creating, by a system comprising a processor, a multimedia presentation associated with an event related to a user and a location of a mobile device. The creating can include operations 1104-1116. Operation 1104 represents obtaining location data representing the location of the mobile device. Operation 1106 represents determining availability of a group of sensors within a proximity of the user device, the group comprising a multimedia sensor of the mobile device. Operation 1108 represents communicating the availability of the group of sensors for selection via a user interface on the mobile device. Operation 1110 represents receiving a selection, obtained via the user interface, of a source group, resulting in a selected source group, the selected source group comprising at least a subgroup of the group of sensors. Operation 1112 represents receiving sensor data obtained by the selected source group. Operation 1114 represents combining the sensor data received from the selected source group to create the multimedia presentation associated with the event. Operation 1116 represents outputting the multimedia presentation.

Further operations can include combining, by the system, the sensor data received from the selected source group with media content to create the multimedia presentation.

Further operations can include facilitating, by the system, payment at least one of: to a first entity associated with a commercially offered sensor of the selected source group, or to a second entity associated with commercially offered multimedia content of the media content.

Receiving the sensor data obtained by the selected source group can include receiving sensor data collected from at least one of: a camera, a microphone, an environment data sensor, or a biometric data sensor.

Further operations can include obtaining, by the system, annotation data, and incorporating, by the system, the annotation data into the multimedia presentation.

One or more aspects are represented in FIG. 8, such as implemented in a machine-readable medium, including executable instructions that, when executed by a processor, facilitate performance of operations. Example operation 1202 represents determining a location of a user equipment. Operation 1204 represents determining a multimedia sensor group that outputs accessible media content, the multimedia sensor group comprising a multimedia sensor of the user equipment. Operation 1206 represents communicating multimedia sensor group data indicating at least part of the multimedia sensor group as being available for selection. Operation 1208 represents receiving selection data corresponding to a selection of a multimedia sensor of the multimedia sensors. Operation 1210 represents obtaining received media content based on the selection. Operation 1212 represents combining the received media content with other media content, other than the received media content, to create a multimedia presentation associated with an event associated with the location.

Further operations can include sending a preview of media content corresponding to a multimedia sensor within the at least the part of the multimedia sensor group for displaying on the user equipment as being available for selection.

Further operations can include receiving an annotation for inclusion in the multimedia presentation.

Further operations can include obtaining a pre-stored media file for inclusion in the multimedia presentation.

As can be seen, the technology described herein facilitates autonomous detection of available content and data sources with respect to a user-experienced event. The user can participate via content source selection and user-added annotations. The collection of real-time data and previously-stored content/data can be used to create and post and/or store a multimedia presentation of the event, including posting the multimedia presentation to the user's social media account.

Turning to aspects in general, a wireless communication system can employ various cellular systems, technologies, and modulation schemes to facilitate wireless radio communications between devices (e.g., a UE and the network equipment). While example embodiments might be described for 5G new radio (NR) systems, the embodiments can be applicable to any radio access technology (RAT) or multi-RAT system where the UE operates using multiple carriers e.g. LTE FDD/TDD, GSM/GERAN, CDMA2000 etc. For example, the system can operate in accordance with global system for mobile communications (GSM), universal mobile telecommunications service (UMTS), long term evolution (LTE), LTE frequency division duplexing (LTE FDD, LTE time division duplexing (TDD), high speed packet access (HSPA), code division multiple access (CDMA), wideband CDMA (WCMDA), CDMA2000, time division multiple access (TDMA), frequency division multiple access (FDMA), multi-carrier code division multiple access (MC-CDMA), single-carrier code division multiple access (SC-CDMA), single-carrier FDMA (SC-FDMA), orthogonal frequency division multiplexing (OFDM), discrete Fourier transform spread OFDM (DFT-spread OFDM) single carrier FDMA (SC-FDMA), Filter bank based multi-carrier (FBMC), zero tail DFT-spread-OFDM (ZT DFT-s-OFDM), generalized frequency division multiplexing (GFDM), fixed mobile convergence (FMC), universal fixed mobile convergence (UFMC), unique word OFDM (UW-OFDM), unique word DFT-spread OFDM (UW DFT-Spread-OFDM), cyclic prefix OFDM CP-OFDM, resource-block-filtered OFDM, Wi Fi, WLAN, WiMax, and the like. However, various features and functionalities of system are particularly described wherein the devices (e.g., the UEs and the network equipment) of the system are configured to communicate wireless signals using one or more multi carrier modulation schemes, wherein data symbols can be transmitted simultaneously over multiple frequency subcarriers (e.g., OFDM, CP-OFDM, DFT-spread OFDM, UFMC, FMBC, etc.). The embodiments are applicable to single carrier as well as to multicarrier (MC) or carrier aggregation (CA) operation of the UE. The term carrier aggregation (CA) is also called (e.g. interchangeably called) “multi-carrier system”, “multi-cell operation”, “multi-carrier operation”, “multi-carrier” transmission and/or reception. Note that some embodiments are also applicable for Multi RAB (radio bearers) on some carriers (that is data plus speech is simultaneously scheduled).

In various embodiments, the system can be configured to provide and employ 5G wireless networking features and functionalities. With 5G networks that may use waveforms that split the bandwidth into several sub-bands, different types of services can be accommodated in different sub-bands with the most suitable waveform and numerology, leading to improved spectrum utilization for 5G networks. Notwithstanding, in the mmWave spectrum, the millimeter waves have shorter wavelengths relative to other communications waves, whereby mmWave signals can experience severe path loss, penetration loss, and fading. However, the shorter wavelength at mmWave frequencies also allows more antennas to be packed in the same physical dimension, which allows for large-scale spatial multiplexing and highly directional beamforming.

Performance can be improved if both the transmitter and the receiver are equipped with multiple antennas. Multi-antenna techniques can significantly increase the data rates and reliability of a wireless communication system. The use of multiple input multiple output (MIMO) techniques, which was introduced in the third-generation partnership project (3GPP) and has been in use (including with LTE), is a multi-antenna technique that can improve the spectral efficiency of transmissions, thereby significantly boosting the overall data carrying capacity of wireless systems. The use of multiple-input multiple-output (MIMO) techniques can improve mmWave communications; MIMO can be used for achieving diversity gain, spatial multiplexing gain and beamforming gain.

Note that using multi-antennas does not always mean that MIMO is being used. For example, a configuration can have two downlink antennas, and these two antennas can be used in various ways. In addition to using the antennas in a 2×2 MIMO scheme, the two antennas can also be used in a diversity configuration rather than MIMO configuration. Even with multiple antennas, a particular scheme might only use one of the antennas (e.g., LTE specification's transmission mode 1, which uses a single transmission antenna and a single receive antenna). Or, only one antenna can be used, with various different multiplexing, precoding methods etc.

The MIMO technique uses a commonly known notation (M×N) to represent MIMO configuration in terms number of transmit (M) and receive antennas (N) on one end of the transmission system. The common MIMO configurations used for various technologies are: (2×1), (1×2), (2×2), (4×2), (8×2) and (2×4), (4×4), (8×4). The configurations represented by (2×1) and (1×2) are special cases of MIMO known as transmit diversity (or spatial diversity) and receive diversity. In addition to transmit diversity (or spatial diversity) and receive diversity, other techniques such as spatial multiplexing (including both open-loop and closed-loop), beamforming, and codebook-based precoding can also be used to address issues such as efficiency, interference, and range.

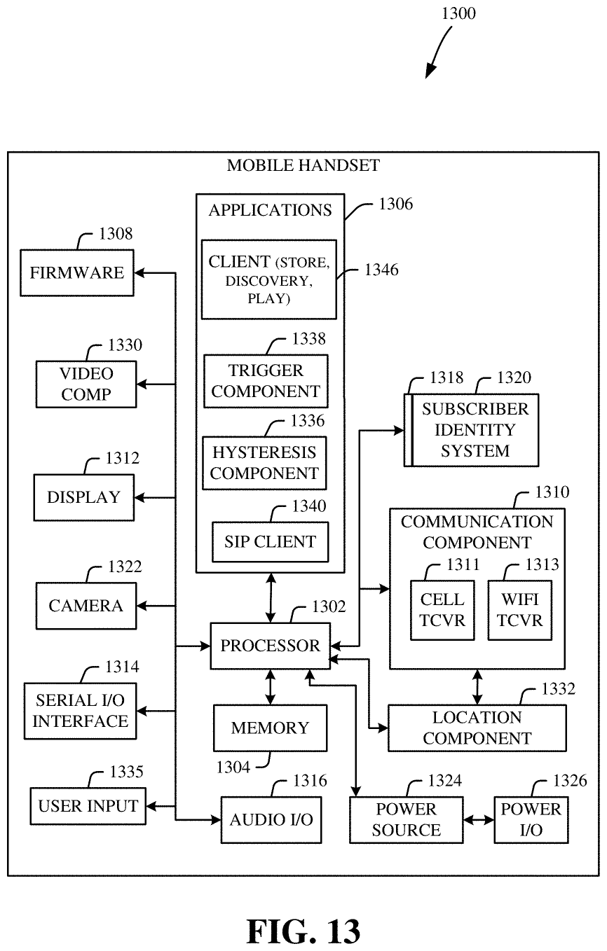

Referring now to FIG. 13, illustrated is a schematic block diagram of an example end-user device (such as user equipment) that can be a mobile device 1300 capable of connecting to a network in accordance with some embodiments described herein. Although a mobile handset 1300 is illustrated herein, it will be understood that other devices can be a mobile device, and that the mobile handset 1300 is merely illustrated to provide context for the embodiments of the various embodiments described herein. The following discussion is intended to provide a brief, general description of an example of a suitable environment 1300 in which the various embodiments can be implemented. While the description includes a general context of computer-executable instructions embodied on a machine-readable storage medium, those skilled in the art will recognize that the various embodiments also can be implemented in combination with other program modules and/or as a combination of hardware and software.

Generally, applications (e.g., program modules) can include routines, programs, components, data structures, etc., that perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device can typically include a variety of machine-readable media. Machine-readable media can be any available media that can be accessed by the computer and includes both volatile and non-volatile media, removable and non-removable media. By way of example and not limitation, computer-readable media can include computer storage media and communication media. Computer storage media can include volatile and/or non-volatile media, removable and/or non-removable media implemented in any method or technology for storage of information, such as computer-readable instructions, data structures, program modules or other data. Computer storage media can include, but is not limited to, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The handset 1300 includes a processor 1302 for controlling and processing all onboard operations and functions. A memory 1304 interfaces to the processor 1302 for storage of data and one or more applications 1306 (e.g., a video player software, user feedback component software, etc.). Other applications can include voice recognition of predetermined voice commands that facilitate initiation of the user feedback signals. The applications 1306 can be stored in the memory 1304 and/or in a firmware 1308, and executed by the processor 1302 from either or both the memory 1304 or/and the firmware 1308. The firmware 1308 can also store startup code for execution in initializing the handset 1300. A communications component 1310 interfaces to the processor 1302 to facilitate wired/wireless communication with external systems, e.g., cellular networks, VoIP networks, and so on. Here, the communications component 1310 can also include a suitable cellular transceiver 1311 (e.g., a GSM transceiver) and/or an unlicensed transceiver 1313 (e.g., Wi-Fi, WiMax) for corresponding signal communications. The handset 1300 can be a device such as a cellular telephone, a PDA with mobile communications capabilities, and messaging-centric devices. The communications component 1310 also facilitates communications reception from terrestrial radio networks (e.g., broadcast), digital satellite radio networks, and Internet-based radio services networks.

The handset 1300 includes a display 1312 for displaying text, images, video, telephony functions (e.g., a Caller ID function), setup functions, and for user input. For example, the display 1312 can also be referred to as a “screen” that can accommodate the presentation of multimedia content (e.g., music metadata, messages, wallpaper, graphics, etc.). The display 1312 can also display videos and can facilitate the generation, editing and sharing of video quotes. A serial I/O interface 1314 is provided in communication with the processor 1302 to facilitate wired and/or wireless serial communications (e.g., USB, and/or IEEE 1394) through a hardwire connection, and other serial input devices (e.g., a keyboard, keypad, and mouse). This supports updating and troubleshooting the handset 1300, for example. Audio capabilities are provided with an audio I/O component 1316, which can include a speaker for the output of audio signals related to, for example, indication that the user pressed the proper key or key combination to initiate the user feedback signal. The audio I/O component 1316 also facilitates the input of audio signals through a microphone to record data and/or telephony voice data, and for inputting voice signals for telephone conversations.

The handset 1300 can include a slot interface 1318 for accommodating a SIC (Subscriber Identity Component) in the form factor of a card Subscriber Identity Module (SIM) or universal SIM 1320, and interfacing the SIM card 1320 with the processor 1302. However, it is to be appreciated that the SIM card 1320 can be manufactured into the handset 1300, and updated by downloading data and software.

The handset 1300 can process IP data traffic through the communication component 1310 to accommodate IP traffic from an IP network such as, for example, the Internet, a corporate intranet, a home network, a person area network, etc., through an ISP or broadband cable provider. Thus, VoIP traffic can be utilized by the handset 800 and IP-based multimedia content can be received in either an encoded or decoded format.

A video processing component 1322 (e.g., a camera) can be provided for decoding encoded multimedia content. The video processing component 1322 can aid in facilitating the generation, editing and sharing of video quotes. The handset 1300 also includes a power source 1324 in the form of batteries and/or an AC power subsystem, which power source 1324 can interface to an external power system or charging equipment (not shown) by a power I/O component 1326.

The handset 1300 can also include a video component 1330 for processing video content received and, for recording and transmitting video content. For example, the video component 1330 can facilitate the generation, editing and sharing of video quotes. A location tracking component 1332 facilitates geographically locating the handset 1300. As described hereinabove, this can occur when the user initiates the feedback signal automatically or manually. A user input component 1334 facilitates the user initiating the quality feedback signal. The user input component 1334 can also facilitate the generation, editing and sharing of video quotes. The user input component 1334 can include such conventional input device technologies such as a keypad, keyboard, mouse, stylus pen, and/or touch screen, for example.

Referring again to the applications 1306, a hysteresis component 1336 facilitates the analysis and processing of hysteresis data, which is utilized to determine when to associate with the access point. A software trigger component 1338 can be provided that facilitates triggering of the hysteresis component 1338 when the Wi-Fi transceiver 1313 detects the beacon of the access point. A SIP client 1340 enables the handset 1300 to support SIP protocols and register the subscriber with the SIP registrar server. The applications 1306 can also include a client 1342 that provides at least the capability of discovery, play and store of multimedia content, for example, music.

The handset 1300, as indicated above related to the communications component 810, includes an indoor network radio transceiver 1313 (e.g., Wi-Fi transceiver). This function supports the indoor radio link, such as IEEE 802.11, for the dual-mode GSM handset 1300. The handset 1300 can accommodate at least satellite radio services through a handset that can combine wireless voice and digital radio chipsets into a single handheld device.

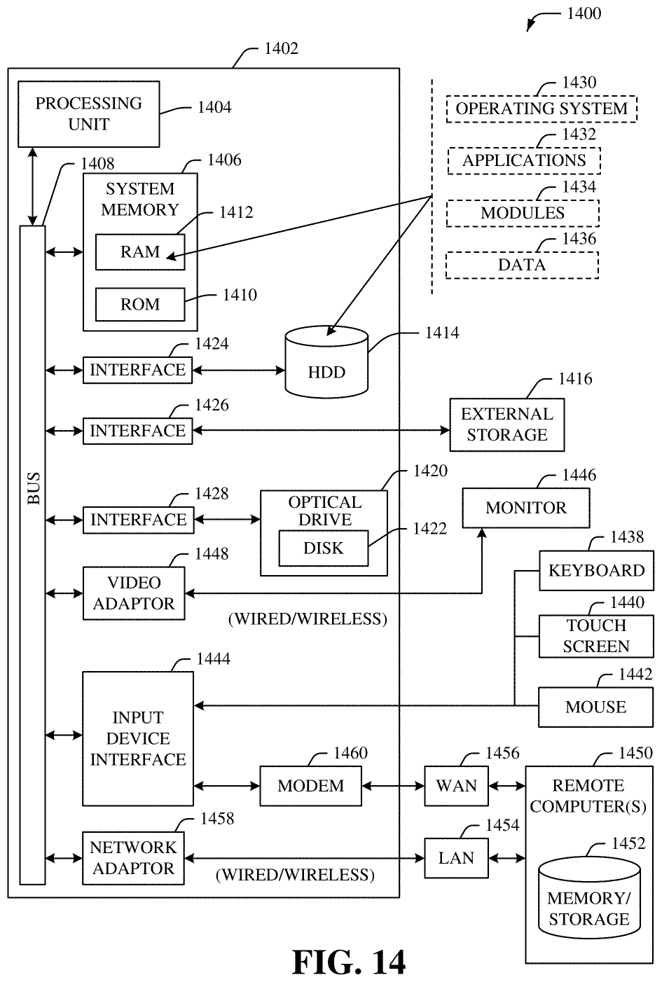

In order to provide additional context for various embodiments described herein, FIG. 14 and the following discussion are intended to provide a brief, general description of a suitable computing environment 1400 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 14, the example environment 1400 for implementing various embodiments of the aspects described herein includes a computer 1402, the computer 1402 including a processing unit 1404, a system memory 1406 and a system bus 1408. The system bus 1408 couples system components including, but not limited to, the system memory 1406 to the processing unit 1404. The processing unit 1404 can be any of various commercially available processors. Dual microprocessors and other multi-processor architectures can also be employed as the processing unit 1404.

The system bus 1408 can be any of several types of bus structure that can further interconnect to a memory bus (with or without a memory controller), a peripheral bus, and a local bus using any of a variety of commercially available bus architectures. The system memory 1406 includes ROM 1410 and RAM 1412. A basic input/output system (BIOS) can be stored in a non-volatile memory such as ROM, erasable programmable read only memory (EPROM), EEPROM, which BIOS contains the basic routines that help to transfer information between elements within the computer 1402, such as during startup. The RAM 1412 can also include a high-speed RAM such as static RAM for caching data.

The computer 1402 further includes an internal hard disk drive (HDD) 1414 (e.g., EIDE, SATA), one or more external storage devices 1416 (e.g., a magnetic floppy disk drive (FDD) 1416, a memory stick or flash drive reader, a memory card reader, etc.) and an optical disk drive 1420 (e.g., which can read or write from a CD-ROM disc, a DVD, a BD, etc.). While the internal HDD 1414 is illustrated as located within the computer 1402, the internal HDD 1414 can also be configured for external use in a suitable chassis (not shown). Additionally, while not shown in environment 1400, a solid state drive (SSD), non-volatile memory and other storage technology could be used in addition to, or in place of, an HDD 1414, and can be internal or external. The HDD 1414, external storage device(s) 1416 and optical disk drive 1420 can be connected to the system bus 1408 by an HDD interface 1424, an external storage interface 1426 and an optical drive interface 1428, respectively. The interface 1424 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1402, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1412, including an operating system 1430, one or more application programs 1432, other program modules 1434 and program data 1436. All or portions of the operating system, applications, modules, and/or data can also be cached in the RAM 1412. The systems and methods described herein can be implemented utilizing various commercially available operating systems or combinations of operating systems.

Computer 1402 can optionally include emulation technologies. For example, a hypervisor (not shown) or other intermediary can emulate a hardware environment for operating system 1430, and the emulated hardware can optionally be different from the hardware illustrated in FIG. 14. In such an embodiment, operating system 1430 can include one virtual machine (VM) of multiple VMs hosted at computer 1402. Furthermore, operating system 1430 can provide runtime environments, such as the Java runtime environment or the .NET framework, for applications 1432. Runtime environments are consistent execution environments that allow applications 1432 to run on any operating system that includes the runtime environment. Similarly, operating system 1430 can support containers, and applications 1432 can be in the form of containers, which are lightweight, standalone, executable packages of software that include, e.g., code, runtime, system tools, system libraries and settings for an application.

Further, computer 1402 can be enabled with a security module, such as a trusted processing module (TPM). For instance with a TPM, boot components hash next in time boot components, and wait for a match of results to secured values, before loading a next boot component. This process can take place at any layer in the code execution stack of computer 1402, e.g., applied at the application execution level or at the operating system (OS) kernel level, thereby enabling security at any level of code execution.

A user can enter commands and information into the computer 1402 through one or more wired/wireless input devices, e.g., a keyboard 1438, a touch screen 1440, and a pointing device, such as a mouse 1442. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1404 through an input device interface 1444 that can be coupled to the system bus 1408, but can be connected by other interfaces, such as a parallel port, an IEEE 1394 serial port, a game port, a USB port, an IR interface, a BLUETOOTH® interface, etc.

A monitor 1446 or other type of display device can be also connected to the system bus 1408 via an interface, such as a video adapter 1448. In addition to the monitor 1446, a computer typically includes other peripheral output devices (not shown), such as speakers, printers, etc.

The computer 1402 can operate in a networked environment using logical connections via wired and/or wireless communications to one or more remote computers, such as a remote computer(s) 1450. The remote computer(s) 1450 can be a workstation, a server computer, a router, a personal computer, portable computer, microprocessor-based entertainment appliance, a peer device or other common network node, and typically includes many or all of the elements described relative to the computer 1402, although, for purposes of brevity, only a memory/storage device 1452 is illustrated. The logical connections depicted include wired/wireless connectivity to a local area network (LAN) 1454 and/or larger networks, e.g., a wide area network (WAN) 1456. Such LAN and WAN networking environments are commonplace in offices and companies, and facilitate enterprise-wide computer networks, such as intranets, all of which can connect to a global communications network, e.g., the Internet.

When used in a LAN networking environment, the computer 1402 can be connected to the local network 1454 through a wired and/or wireless communication network interface or adapter 1458. The adapter 1458 can facilitate wired or wireless communication to the LAN 1454, which can also include a wireless access point (AP) disposed thereon for communicating with the adapter 1458 in a wireless mode.

When used in a WAN networking environment, the computer 1402 can include a modem 1460 or can be connected to a communications server on the WAN 1456 via other means for establishing communications over the WAN 1456, such as by way of the Internet. The modem 1460, which can be internal or external and a wired or wireless device, can be connected to the system bus 1408 via the input device interface 1444. In a networked environment, program modules depicted relative to the computer 1402 or portions thereof, can be stored in the remote memory/storage device 1452. It will be appreciated that the network connections shown are example and other means of establishing a communications link between the computers can be used.

When used in either a LAN or WAN networking environment, the computer 1402 can access cloud storage systems or other network-based storage systems in addition to, or in place of, external storage devices 1416 as described above. Generally, a connection between the computer 1402 and a cloud storage system can be established over a LAN 1454 or WAN 1456 e.g., by the adapter 1458 or modem 1460, respectively. Upon connecting the computer 1402 to an associated cloud storage system, the external storage interface 1426 can, with the aid of the adapter 1458 and/or modem 1460, manage storage provided by the cloud storage system as it would other types of external storage. For instance, the external storage interface 1426 can be configured to provide access to cloud storage sources as if those sources were physically connected to the computer 1402.

The computer 1402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The computer is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE802.11 (a, b, g, n, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 2.4 and 8 GHz radio bands, at an 14 Mbps (802.11b) or 84 Mbps (802.11a) data rate, for example, or with products that contain both bands (dual band), so the networks can provide real-world performance similar to the basic “10BaseT” wired Ethernet networks used in many offices.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor also can be implemented as a combination of computing processing units.

In the subject specification, terms such as “store,” “data store,” “data storage,” “database,” “repository,” “queue”, and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory. In addition, memory components or memory elements can be removable or stationary. Moreover, memory can be internal or external to a device or component, or removable or stationary. Memory can include various types of media that are readable by a computer, such as hard-disc drives, zip drives, magnetic cassettes, flash memory cards or other types of memory cards, cartridges, or the like.

By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to include, without being limited, these and any other suitable types of memory.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated example aspects of the embodiments. In this regard, it will also be recognized that the embodiments include a system as well as a computer-readable medium having computer-executable instructions for performing the acts and/or events of the various methods.

Computing devices typically include a variety of media, which can include computer-readable storage media and/or communications media, which two terms are used herein differently from one another as follows. Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, solid state drive (SSD) or other solid-state storage technology, compact disk read only memory (CD ROM), digital versatile disk (DVD), Blu-ray disc or other optical disk storage, magnetic cassettes, magnetic tape, magnetic disk storage or other magnetic storage devices or other tangible and/or non-transitory media which can be used to store desired information.

In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communications media include wired media, such as a wired network or direct-wired connection, and wireless media such as acoustic, RF, infrared and other wireless media

Further, terms like “user equipment,” “user device,” “mobile device,” “mobile,” station,” “access terminal,” “terminal,” “handset,” and similar terminology, generally refer to a wireless device utilized by a subscriber or user of a wireless communication network or service to receive or convey data, control, voice, video, sound, gaming, or substantially any data-stream or signaling-stream. The foregoing terms are utilized interchangeably in the subject specification and related drawings. Likewise, the terms “access point,” “node B,” “base station,” “evolved Node B,” “cell,” “cell site,” and the like, can be utilized interchangeably in the subject application, and refer to a wireless network component or appliance that serves and receives data, control, voice, video, sound, gaming, or substantially any data-stream or signaling-stream from a set of subscriber stations. Data and signaling streams can be packetized or frame-based flows. It is noted that in the subject specification and drawings, context or explicit distinction provides differentiation with respect to access points or base stations that serve and receive data from a mobile device in an outdoor environment, and access points or base stations that operate in a confined, primarily indoor environment overlaid in an outdoor coverage area. Data and signaling streams can be packetized or frame-based flows.

Furthermore, the terms “user,” “subscriber,” “customer,” “consumer,” and the like are employed interchangeably throughout the subject specification, unless context warrants particular distinction(s) among the terms. It should be appreciated that such terms can refer to human entities, associated devices, or automated components supported through artificial intelligence (e.g., a capacity to make inference based on complex mathematical formalisms) which can provide simulated vision, sound recognition and so forth. In addition, the terms “wireless network” and “network” are used interchangeable in the subject application, when context wherein the term is utilized warrants distinction for clarity purposes such distinction is made explicit.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In addition, while a particular feature may have been disclosed with respect to only one of several implementations, such feature may be combined with one or more other features of the other implementations as may be desired and advantageous for any given or particular application. Furthermore, to the extent that the terms “includes” and “including” and variants thereof are used in either the detailed description or the claims, these terms are intended to be inclusive in a manner similar to the term “comprising.”

The above descriptions of various embodiments of the subject disclosure and corresponding figures and what is described in the Abstract, are described herein for illustrative purposes, and are not intended to be exhaustive or to limit the disclosed embodiments to the precise forms disclosed. It is to be understood that one of ordinary skill in the art may recognize that other embodiments having modifications, permutations, combinations, and additions can be implemented for performing the same, similar, alternative, or substitute functions of the disclosed subject matter, and are therefore considered within the scope of this disclosure. Therefore, the disclosed subject matter should not be limited to any single embodiment described herein, but rather should be construed in breadth and scope in accordance with the claims below.

What is claimed is:

1. A system, comprising:
a processor; and
a memory that stores executable instructions that, when executed by the processor of the system, facilitate performance of operations, the operations comprising:
creating a multimedia file associated with an event related to a user, the event associated with location data representing a location of the user device, the creating comprising:
obtaining the location data from a user device;
determining availability of a group of multimedia sensors within a proximity of the location of the user device, the group comprising a multimedia sensor of the user device;
communicating the availability of the group of multimedia sensors for selection via a user interface on the device;
receiving a selection, obtained via the user interface, of a multimedia source group, resulting in a selected multimedia source group, the selected multimedia source group comprising the group of multimedia sensors;
receiving media content obtained by the selected multimedia source group; and
combining the media content received from the selected multimedia source group with other media content, other than the media content, to create the multimedia file associated with the event.

2. The system of claim 1, wherein the operations further comprise accessing the multimedia file for outputting as a presentation in response to a request from the user.

3. The system of claim 1, wherein the operations further comprise outputting the multimedia file to a user-specified data store.

4. The system of claim 1, wherein the operations further comprise outputting the multimedia file to a user-specified social media account.

5. The system of claim 1, wherein the other media content comprises at least one of: audio content, video content, image content animation content, or text content.

6. The system of claim 1, wherein the other media content comprises at least one of: media content selected by the user, or filler content selected by the system.

7. The system of claim 1, wherein the presentation of the available multimedia sensors comprises respective previews for respective multimedia sensors of the group of multimedia sensors.

8. The system of claim 1, wherein the operations further comprise receiving an annotation from the user device for inclusion in the multimedia file.

9. The system of claim 1, wherein the operations further comprise receiving a pre-stored media file for inclusion in the multimedia file.

10. The system of claim 1, wherein the operations further comprise facilitating payment to an entity associated with a commercially offered multimedia sensor of the selected multimedia source group.

11. The system of claim 1, wherein the operations further comprise facilitating payment to an entity associated with commercially offered multimedia of the other multimedia content.

12. A method, comprising:
creating, by a system comprising a processor, a multimedia presentation associated with an event related to a user and a location of a mobile device, the creating comprising:
obtaining location data representing the location of the mobile device;
determining availability of a group of sensors within a proximity of the user device, the group comprising a multimedia sensor of the mobile device;
communicating the availability of the group of sensors for selection via a user interface on the mobile device;
receiving a selection, obtained via the user interface, of a source group, resulting in a selected source group, the selected source group comprising at least a subgroup of the group of sensors;
receiving sensor data obtained by the selected source group;
combining the sensor data received from the selected source group to create the multimedia presentation associated with the event; and
outputting the multimedia presentation.

13. The method of claim 12, further comprising combining, by the system, the sensor data received from the selected source group with media content to create the multimedia presentation.

14. The method of claim 13, further comprising facilitating, by the system, payment at least one of: to a first entity associated with a commercially offered sensor of the selected source group, or to a second entity associated with commercially offered multimedia content of the media content.

15. The method of claim 12, wherein receiving the sensor data obtained by the selected source group comprises receiving sensor data collected from at least one of: a camera, a microphone, an environment data sensor, or a biometric data sensor.

16. The method of claim 12, further comprising obtaining, by the system, annotation data, and incorporating, by the system, the annotation data into the multimedia presentation.

17. A non-transitory machine-readable medium, comprising executable instructions that, when executed by a processor, facilitate performance of operations, the operations comprising:
determining a location of a user equipment;
determining a multimedia sensor group that outputs accessible media content, the multimedia sensor group comprising a multimedia sensor of the user equipment;
communicating multimedia sensor group data indicating at least part of the multimedia sensor group as being available for selection;
receiving selection data corresponding to a selection of a multimedia sensor of the multimedia sensors;
obtaining received media content based on the selection; and
combining the received media content with other media content, other than the received media content, to create a multimedia presentation associated with an event associated with the location.

18. The non-transitory machine-readable medium of claim 17, wherein the operations further comprise sending a preview of media content corresponding to a multimedia sensor within at least the part of the multimedia sensor group for displaying on the user equipment as being available for selection.

19. The non-transitory machine-readable medium of claim 17, wherein the operations further comprise receiving an annotation for inclusion in the multimedia presentation.

20. The non-transitory machine-readable medium of claim 17, wherein the operations further comprise obtaining a pre-stored media file for inclusion in the multimedia presentation.
